(19) United States
(12) Patent Application Publication
(10) Pub. No.: US 2021/0398364 A1
(43) Pub. Date: Dec. 23, 2021

(54) METHOD FOR EXECUTING ONE OR MORE VEHICLE APPLICATIONS USING A VEHICLE COMPUTATION UNIT OF A VEHICLE, VEHICLE COMPUTATION UNIT, METHOD FOR PROVIDING A PERMISSION INFORMATION MANIFEST FOR A VEHICLE APPLICATION, PERMISSION INFORMATION MANIFEST FOR A VEHICLE APPLICATION AND COMPUTER PROGRAM

(71) Applicant: Volkswagen Aktiengesellschaft, Wolfsburg (DE)

(72) Inventors: Alexander Tschache, Wolfsburg (DE); Udo Steinberg, Braunschweig (DE)

(21) Appl. No.: 17/281,892

(22) PCT Filed: Sep. 30, 2019
(86) PCT No.: PCT/EP2019/076432

§ 371 Date: Mar. 31, 2021

(30) Foreign Application Priority Data
Oct. 2, 2018 (EP) 18198278.6

(51) Int. Cl. G07C 5/00; G06F 8/65; G06F 8/71; H04L 9/32

(52) U.S. Cl. CPC G07C 5/008; G06F 8/65; H04L 9/3236; H04L 9/3247; G06F 8/71

(57) ABSTRACT

Executing one or more vehicle applications using a vehicle computation unit of a vehicle and providing a permission information manifest for a vehicle application, and controlling a communication between vehicle applications of a vehicle based on permission information manifests associated with the vehicle applications. Programming instructions of the one or more vehicle applications are obtained, as well as one or more individual permission information manifests of the one or more vehicle applications. Each permission information manifest includes information related to one or more permitted vehicle services of a vehicle application of the one or more vehicle applications. The information related to the one or more permitted services indicates one or more vehicle services the vehicle application is permitted to offer to further vehicle applications of the vehicle and/or one or more vehicle services of the further vehicle applications the vehicle application is permitted to use.

### RELATED APPLICATIONS

The present application claims priority to International Pat. App. No. PCT/EP2019/076432 to Alexander Tschache, et al., filed Sep. 30, 2019, titled “Method For Executing One or More Vehicle Applications Using a Vehicle Computation Unit of a Vehicle, Vehicle Computation Unit, Method for Providing a Permission Information Manifest for a Vehicle Application, Permission Information Manifest for a Vehicle Application and Computer Program”, which claims priority to European Pat. App. No. 18198278.6, filed Oct. 2, 2018, the contents of each being incorporated by reference in their entirety herein.

### FIELD OF TECHNOLOGY

The present disclosure relates to technologies and techniques for executing one or more vehicle applications using a vehicle computation unit of a vehicle, a vehicle computation unit, a method for providing a permission information manifest for a vehicle application, a permission information manifest for a vehicle application and a computer program, more specifically, but not exclusively, to controlling a communication between vehicle applications of a vehicle based on permission information manifests associated with the vehicle applications.

### BACKGROUND

The communication among control units of a vehicle is a field of research and development. A vehicle may comprise a multitude of different control units, which are often provided by third party suppliers to a vehicle manufacturer. Such control units may be compromised, for example, because they are “hacked” by an attacker or because the supplier has included backdoor functionality within the control unit. To limit the damage, in some systems, each control unit may be placed in an isolated network, and a star-shaped topology may be used to connect the control units using a security gateway as the central node of the star-shaped topology. This may require a complex maintenance of the isolated networks and may provide both a single point of failure and a single point of attack to malicious actors.

In patent application DE 10 201 1 075 416 A1, as a further security measure, each interface of a control unit comprises an interface index. If, during a diagnosis of the system, an interface index is found that is not contained within a table of indices allowed within the vehicle, a warning is displayed and the respective component control unit associated with the interface index may be blocked.

There may be a desire for an improved communication approach for vehicle control units within a vehicle, which avoids a single point of failure and/or a single point of attack.

### SUMMARY

Examples provided herein are based on the finding that all vehicle applications, which are executed by vehicle computation units, may be connected using a (single) network, e.g. an Ethernet network. In some examples, vehicle computation units may host one or more vehicle applications each. The vehicle applications provide services for other vehicle applications. These services may range from access to vehicle driving functionality (e.g. providing a sensor readout or activating a driving functionality) to entertainment features of the vehicle. To safeguard against malicious vehicle applications gaining access to services they should not have access to, each vehicle application may be associated with a permission information manifest that defines which services said vehicle application is permitted to offer, and which services said vehicle application is permitted to use. Based on this permission information manifest, and based on the permission information manifests of other vehicle applications, which may be executed by further computation units, the vehicle computation unit may limit the communication of the vehicle application to the further vehicle applications said vehicle application is permitted to use and to the further vehicle applications, that are permitted to use said vehicle application. As the permission information manifest is associated with a limited (e.g., single) vehicle application, an update of the vehicle application might only require the generation of a new permission information manifest for the updated vehicle application, and no changes at the other vehicle application. To secure the generation of the permission information manifests, the permission information manifests may be preferably secured using a cryptographic signature, which is based on the permission information, the programming instructions of the vehicle application, and a (private) cryptographic key.

In some examples, a method is disclosed for executing one or more vehicle applications using a vehicle computation unit of a vehicle. The method may include obtaining programming instructions of the one or more vehicle applications. One or more individual permission information manifests of the one or more vehicle applications may be obtained. Each permission information manifest of the one or more individual permission manifests may include information related to one or more permitted vehicle services of a vehicle application of the one or more vehicle applications. The information related to the one or more permitted services indicates one or more vehicle services the vehicle application is permitted to offer to further vehicle applications of the vehicle and/or one or more vehicle services of the further vehicle applications the vehicle application is permitted to use. The method further includes executing the one or more vehicle applications based on the programming instructions and based on the one or more individual permission information manifests using the vehicle computation unit. A communication of vehicle applications of the one or more vehicle applications is limited based on the one or more individual permission information manifests. The one or more individual permission manifests may be used to define which communication is permitted for each vehicle application, which may safeguard against malicious vehicle applications and may allow for an easy updatability of individual vehicle applications, e.g. without the need to adjust all other vehicle applications.

In some examples, the method may include receiving one or more further individual permission information manifests from one or more further vehicle computation units of the vehicle. Each permission information manifest of the one or more further individual permission manifests may include information related to one or more permitted vehicle services of a further vehicle application to be executed by the one or more further computation units. The communication of vehicle applications of the one or more vehicle applications may be limited based on the one or more further individual permission information manifests. This may enable the vehicle computation unit to determine, whether a vehicle computation unit, from which communication is received, executes a vehicle application that is permitted to access a service offered by a vehicle application executed by the vehicle computation unit.

The method may include determining a communication permission data structure for the one or more vehicle applications based on the one or more individual permission information manifests and based on the one or more further individual permission information manifests. The communication of the one or more vehicle applications may be limited based on the communication permission data structure. The communication permission data structure may be re-generated when a vehicle application is updated, and may include the permission information required by the vehicle computation unit to distinguish permissible from impermissible communication.

For example, the communication permission data structure may indicate, which of the one or more vehicle applications are permitted to communicate with which further vehicle computation unit of the one or more further vehicle computation units. Additionally or alternatively, the communication permission data structure may indicate which of the one or more further vehicle computation units are permitted to communicate with which vehicle application of the one or more vehicle applications. This may enable the communication unit to distinguish permissible from impermissible communication.

In at least some examples, the one or more further individual permission information manifests may be received in response to a request by the vehicle computation unit. This may enable receiving the individual permission information manifests when they are required by the vehicle computation unit. Alternatively or additionally, the one or more further individual permission information manifests are received as a broadcast of the one or more further vehicle computation units. This may reduce an overhead, as the individual permission information manifests might be transmitted to all vehicle computation units at once.

The one or more individual permission information manifests may each include a cryptographic signature of the individual permission information manifest. The cryptographic signature may be based on based on a cryptographic key, based on the programming instructions of the vehicle application and based on the information related to the one or more permitted vehicle services. The exemplary method further includes validating the individual permission information manifests based on the cryptographic signature. This may safeguard against malicious actors generating or altering permission information manifests to gain additional privileges within the service system.

In some examples, the method further includes providing the one or more individual permission information manifests to one or more further vehicle computation units of the vehicle. This may enable the one or more further vehicle computation units to limit the communication of the further vehicle applications being executed by the one or more further vehicle computation units.

For example, the one or more further individual permission information manifestsmay be provided in response to a request by the one or more further vehicle computation units. This may enable transmitting the individual permission information manifests when they are required by the one or more further vehicle computation units. Additionally or alternatively, the one or more further individual permission information manifests are transmitted as a broadcast to the one or more further vehicle computation units. This may reduce an overhead, as the individual permission information manifests might be transmitted to all vehicle computation units at once.

In various examples, the method includes obtaining an update of a vehicle application of the one or more vehicle applications. The update may include updated programming instructions of the vehicle application and an updated permission information manifest. The method may further include providing all of the one or more individual permission information manifests to the one or more further vehicle computation units of the vehicle, including the updated permission information manifest of the updated vehicle application. This may enable an update of individual applications while avoiding that the one or more vehicle computation units partially use outdated permission information manifests. For example, the one or more individual permission information manifests may be provided to the one or more further vehicle computation units with a versioning information. The versioning information for all of the one or more individual permission information manifests may be changed if an updated version of a vehicle application is obtained. This may avoid that the one or more vehicle computation units partially use outdated permission information manifests.

In at least some examples, the communication of a vehicle application of the one or more vehicle applications with further vehicle applications of the one or more vehicle applications is limited based on the one or more individual permission information manifests. This may enable a containment of individual vehicle applications within a vehicle computation units. Additionally or alternatively, the communication of a vehicle application of the one or more vehicle applications with further vehicle applications of one or more further vehicle applications may be limited based on the one or more individual permission information manifests and based on one or more further individual permission information manifests. This may enable controlling the communication transmitted to or received from other vehicle communications units.

Some examples further provide a method for providing a permission information manifest for a vehicle application. The method includes obtaining programming instructions of the vehicle application. The method further includes determining information related to one or more permitted vehicle services of the vehicle application. The information related to the one or more permitted services indicates one or more vehicle services the vehicle application is permitted to offer to further vehicle applications of the vehicle and/or one or more vehicle service of the further vehicle applications the vehicle application is permitted to use. The method further includes generating a permission information manifest based on the information related to one or more permitted vehicle services of the vehicle application and based on the programming instructions of the vehicle application. The permission information manifest includes a cryptographic signature and the information related to the one or more permitted vehicle services. The generating of the permission information manifest includes generating the cryptographic signature for the permission information manifest based on a cryptographic key, based on the programming instructions of the vehicle application and based on the information related to the one or more permitted vehicle services. The permission information manifest may be used to define which communication is permitted for the vehicle application, which may safeguard against malicious vehicle applications and may allow for an easy updatability of the vehicle application, without the need to adjust all other vehicle applications. Embodiments further provide a permission information manifest provided by the method for providing a permission information manifest for a vehicle application.

Some examples further provide a computer program having a program code for performing at least one of the methods, when the computer program is executed on a computer, a processor, or a programmable hardware component.

Some examples further provide a vehicle computation unit for executing one or more vehicle applications. The vehicle computation unit includes an interface for communicating with one or more further vehicle computation units of the vehicle. The vehicle computation unit includes a computation module configured to obtain programming instructions of the one or more vehicle applications. The computation module may be configured to obtain one or more individual permission information manifests of the one or more vehicle applications. Each permission information manifest of the one or more individual permission manifests includes information related to one or more permitted vehicle services of a vehicle application of the one or more vehicle applications. The information related to the one or more permitted services indicates one or more vehicle services the vehicle application is permitted to offer to further vehicle applications of the vehicle and/or one or more vehicle services of the further vehicle applications the vehicle application is permitted to use. The vehicle computation unit may be configured to execute the one or more vehicle applications based on the programming instructions and based on the one or more individual permission information manifests. A communication of vehicle applications of the one or more (executed) vehicle applications is limited based on the one or more individual permission information manifests. The one or more individual permission manifests may be used to define which communication is permitted for each vehicle application, which may safeguard against malicious vehicle applications and may allow for an easy updatability of individual vehicle applications, for example, without the need to adjust all other vehicle applications.

Embodiments further provide a permission information manifest for a vehicle application. The permission information manifest is based on information related to one or more permitted vehicle services of the vehicle application and based on programming instructions of the vehicle application. The information related to the one or more permitted services indicates one or more vehicle services the vehicle application is permitted to offer to further vehicle applications of the vehicle and/or one or more vehicle service of the further vehicle applications the vehicle application is permitted to use. The permission information manifest includes a cryptographic signature and the information related to the one or more permitted vehicle services. The cryptographic signature of the permission information manifest is based on a cryptographic key, based on the programming instructions of the vehicle application and based on the information related to the one or more permitted vehicle services. The permission information manifest may be used to define which communication is permitted for the vehicle application, which may safeguard against malicious vehicle applications and may allow for an easy updatability of the vehicle application, for example, without the need to adjust all other vehicle applications.

### BRIEF DESCRIPTION OF THE DRAWINGS

Some other features or aspects will be described using the following non-limiting embodiments of apparatuses or methods or computer programs or computer program products by way of example only, and with reference to the accompanying figures, in which:

FIG. 1a shows a flow chart of a method for executing one or more vehicle applications using a vehicle computation unit of a vehicle according to some aspects of the present disclosure;

FIG. 1 b shows a flow chart of a method for executing one or more vehicle applications using a vehicle computation unit of a vehicle according to some aspects of the present disclosure;

FIG. 1c shows a block diagram of a vehicle computation unit suitable for executing one or more vehicle applications according to some aspects of the present disclosure;

FIG. 2 shows a flow chart of a method for providing a permission information manifest according to some aspects of the present disclosure; and

FIGS. 3a to 3e show schematic diagrams of a communication between computation units or control units of a vehicle according to some aspects of the present disclosure;

FIGS. 4a to 4e show schematic diagrams of a computation unit or of a control unit of a vehicle according to some aspects of the present disclosure; and

FIGS. 5a and 5b show schematic diagrams of a communication between computation units or control units of a vehicle according to some aspects of the present disclosure.

### DETAILED DESCRIPTION

Various example embodiments will now be described more fully with reference to the accompanying drawings in which some example embodiments are illustrated. In the figures, the thicknesses of lines, layers or regions may be exaggerated for clarity. Optional components may be illustrated using broken, dashed or dotted lines. Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like or similar elements throughout the description of the figures.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements or components, but do not preclude the presence or addition of one or more other features, integers, steps, operations, elements, components or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

At least some examples provide a method for authorization of service communication within a vehicular network. At least some vehicles may use a “service-based” communication method that may differ from vehicular communication methods used in other vehicles. Previously used methods for securing the vehicle communication might not be applicable to the service-based communication. At least some embodiments may be focused on making sure, that a vehicle application is only permitted to perform operations (e.g., offering or using of a service), that it is permitted to use. This may be necessary, as all control units or computation units may be able to freely communicate with any other control unit or computation unit, as there is no fixed division of control units/computation units through a gateway control unit.

The protection of service communication, e.g., via the Internet, is usually based on an authorization using tokens, e.g., based on OAuth (Open Authorization). The generation of the authorization tokens may be performed by a trusted central agency. In a vehicle, this would require a trusted central agency within the vehicle, which would lead to a single point of failure and which would create an additional dependence for a communication between two entities of the vehicle. Furthermore, this trusted central agency would require information related to the permissions to be assigned in the vehicle and would require functionality to authenticate communication nodes that the tokens should be generated for. If a control unit is to obtain additional privileges based on an update, the trusted central agency would also require an update to be able to assign the additional permissions.

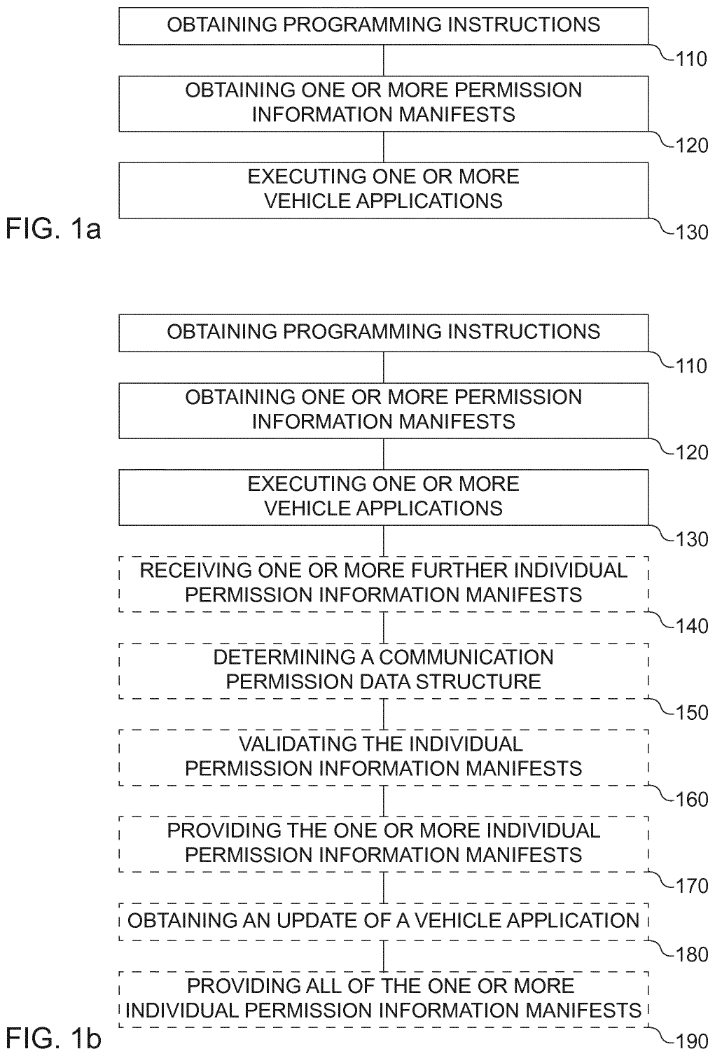

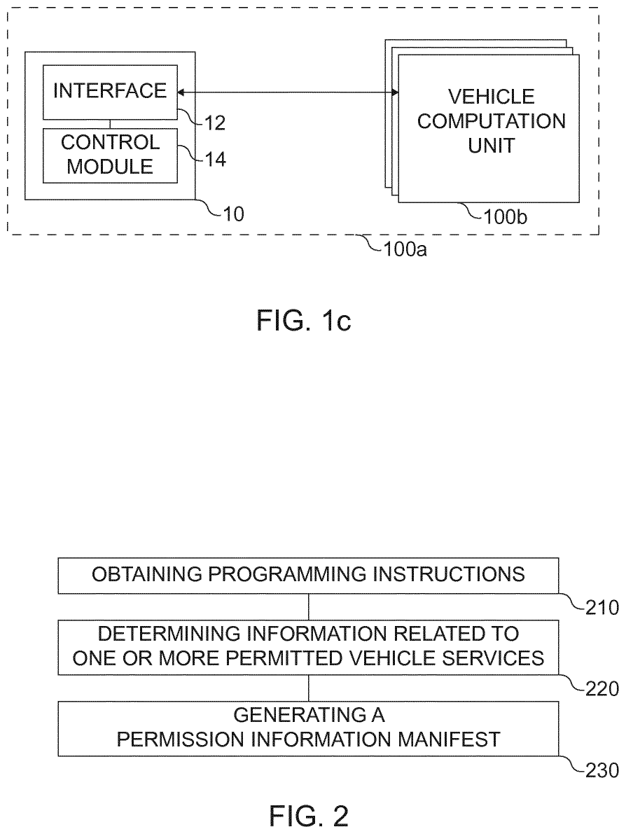

In some examples, each application in the vehicle (e.g., vehicle applications as introduced in connection with FIGS. 1 a to 1c), is associated with a security manifest (e.g., the permission information manifest) that is signed by the vehicle manufacturer. The manifest of a (vehicle) application includes all privileges/permissions that this application is to obtain within the vehicular network, e.g. which services it is permitted to offer or which services it is permitted to consume. Furthermore, the manifest may include information related to a location of the application (e.g., control unit/computation unit or Internet Protocol (IP) address. The entirety of the manifests (e.g., the one or more individual permission information manifests and the one or more further individual permission information manifests combined) may include (all) information (as signed by the vehicle manufacturer) required to verify, whether a particular service communication between two communication nodes are permitted.

During runtime in the vehicle, each control unit/computation unit may collect (all) manifests from (all) other computation units (e.g., the one or more further computation units), may verify the manifests cryptographically, and may create based on these manifests and the own manifests (e.g. the one or more individual permission information manifests) a list or data structure of valid/permissible service communication operations. A control unit/computation unit may be configured to determine:
Is a particular local application (e.g. of the one or more vehicle applications) permitted to use (i.e.“consume”) a particular service?
Is a particular local application permitted to offer a particular service?
Is a particular further computation unit/control unit permitted to offer a particular service?
Is a particular further computation unit/control unit permitted to use a particular service?

If these determinations are used for any kind of service communication, unauthorized vehicle communication may prevented. Thus, a control unit/computation unit that is compromised by hacker might not be able to use services that it wouldn't have been able to use in any case. Embodiments may provide a decentralized method and might not require a trusted central agency within the vehicle. Two communication nodes may be able to mutually prove and verify, that they are permitted to communicate. In case a control unit/computation unit is updated (e.g., by updating a vehicle application hosted by the control unit/computation unit) and is subsequently required to use an additional service, it may receive an additional or updated manifest that includes the additional privileges/permissions. An adjustment of the further control units/computation units/applications might not be required.

More details and aspects of the methods, the permission information fest and/or the vehicle computation unit are mentioned in connection with the proposed concept or one or more examples described above or below (e.g., FIGS. 1a to 5b). The methods, the permission information fest and/or the vehicle computation unit may include one or more additional optional features corresponding to one or more aspects of the proposed concept or one or more examples described above or below.

FIGS. 1 a and 1 b show flow charts of embodiments of a method for executing one or more vehicle applications using a vehicle computation unit of a vehicle. The method includes Obtaining 110 programming instructions of the one or more vehicle applications. The method further includes Obtaining 120 one or more individual permission information manifests of the one or more vehicle applications. Each permission information manifest of the one or more individual permission manifests includes information related to one or more permitted vehicle services of a vehicle application of the one or more vehicle applications. The information related to the one or more permitted services indicates one or more vehicle services the vehicle application is permitted to offer to further vehicle applications of the vehicle. Additionally or alternatively, the information related to the one or more permitted services indicates one or more vehicle services of the further vehicle applications the vehicle application is permitted to use. The method further includes executing 130 the one or more vehicle applications based on the programming instructions and based on the one or more individual permission information manifests using the vehicle computation unit. A communication of vehicle applications of the one or more vehicle applications is limited based on the one or more individual permission information manifests.

FIG. 1c shows a block diagram of a (corresponding) vehicle computation unit 10 for a vehicle 100. The vehicle computation unit 10 is suitable for executing one or more vehicle applications. The vehicle computation unit 10 includes an interface 12 for communicating with one or more further vehicle computation units 100b of the vehicle 100a. The vehicle computation unit 10 includes a computation module 14 configured to obtain programming instructions of the one or more vehicle applications. The computation module 14 is configured to obtain one or more individual permission information manifests of the one or more vehicle applications. Each permission information manifest of the one or more individual permission manifests includes information related to one or more permitted vehicle services of a vehicle application of the one or more vehicle applications. The information related to the one or more permitted services indicates one or more vehicle services the vehicle application is permitted to offer to further vehicle applications of the vehicle. Additionally or alternatively, the information related to the one or more permitted services indicates one or more vehicle services of the further vehicle applications the vehicle application is permitted to use. The computation module 14 is configured to execute the one or more vehicle applications based on the programming instructions and based on the one or more individual permission information manifests. A communication of vehicle applications of the one or more vehicle applications is limited based on the one or more individual permission information manifests. FIG. 1 c further shows the vehicle 100 including the vehicle computation unit 10 and one or more further vehicle communication units 20. In embodiments, the computation module 14 is configured to execute the method steps of the method of FIGS. 1a and/or 1 b, e.g., in conjunction with the interface 12.

The following description may relate to both the method of FIGS. 1 a and/or 1 b and the vehicle computation unit 10 of FIG. 1c.

In some examples, the method may be used to restrict a communication of the one or more vehicle applications to services, that the vehicle applications are permitted to offer to further vehicle applications and/or to services of other vehicle applications, that the vehicle applications are permitted to use. To achieve that, the programming instructions, along with the permission information manifests are obtained for the one or more vehicle applications. The programming instructions are executed, while the permission information manifests are used to determine, which communication of the one or more vehicle applications is permissible.

The method includes obtaining 110 programming instructions of the one or more vehicle applications. For example, the one or more vehicle applications may be software applications suitable for being executed within a vehicular environment, wherein the vehicle applications are adapted to provide a functionality of the vehicle. For example, the one or more vehicle applications may include one or more elements of the group of a logical control unit for a component of the vehicle, a virtual control unit for a component of the vehicle, a monitoring application of the vehicle, a gateway application of the vehicle, a vehicle application related to vehicle entertainment, and a vehicle application for providing an auxiliary service for further vehicle applications.

For example, the programming instructions may include or correspond to executable files of the one or more vehicle applications, e.g., binary executable files or executable files for execution in a runtime environment. Alternatively or additionally, the programming instructions may include a plurality of program instruction based on a programming language or based on a scripting language. In at least some embodiments, the programming instructions may be received via an updating mechanism or via an installation mechanism, e.g. via a direction connection to the vehicle computation unit or via a vehicular network. The programming instructions may be stored within a storage module of the vehicle computation unit. The vehicle computation unit 10 may include the storage module. In at least some embodiments, the storage module may include at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The method includes obtaining 120 one or more individual permission information manifests of the one or more vehicle applications. The one or more individual permission information manifests (and one or more further individual permission information manifests as introduced in the following) may be stored within the storage module of the vehicle computation unit. For example, a permission information manifest may be a file or data structure including information related to one or more permitted vehicle services of a vehicle application of the one or more vehicle applications. For example, a permission information manifest may be a meta- data file associated with a vehicle application. Each permission information manifest may be associated with (exactly) one vehicle application. In some embodiments, each vehicle application may be associated with exactly one permission information manifest. Alternatively, each vehicle application may be associated with one or more individual permission information manifest. A permission information manifest being associated with a vehicle application may correspond to the permission information manifest including information related to one or more permitted vehicle services of the vehicle application.

The information related to the one or more permitted services indicates one or more vehicle services the vehicle application is permitted to offer to further vehicle applications of the vehicle and/or one or more vehicle services of the further vehicle applications the vehicle application is permitted to use. For example, the information related to the one or more permitted services / the one or more individual permission information manifests may define, which services may be offered by the one or more vehicle applications, and/or which services may be used by the one or more vehicle applications, on an application by applications basis. For example, a (single) permission information manifest associated with a vehicle applications may define, which services may be offered by the vehicle application, and/or which services may be used by the vehicle application. Offering a service may correspond to providing a functionality to further applications of the vehicle. Using a service may correspond to accessing a functionality offered by a further application of the vehicle.

In some examples, a service is offered and/or used via a vehicular network. The one or more vehicle applications (or “vehicular applications”) may communicate via the vehicular network or within the vehicle computation unit to offer and/or use a service. For example, the interface 12 may be configured to communicate via the vehicular network. In at least some embodiments, the vehicular network is based on or corresponds to an Ethernet network. The vehicle network may use one or more communication protocols, e.g. the Transmission Control Protocol, the User Datagram Protocol, the Internet Protocol (IP) and/or the Scalable service-Oriented MiddlewarE over IP (SOME/IP) protocol.

The method includes executing 130 the one or more vehicle applications based on the programming instructions and based on the one or more individual permission information manifests using the vehicle computation unit. For example, the programming instructions may include the executable files of the one or more vehicle applications. Executing the one or more vehicle applications may include executing the executable files of the one or more vehicle applications. For example, the one or more vehicle applications may be executed within an operating system environment, e.g. directly or via a runtime environment. For example, the runtime environment may be executed within the operating system environment, and at least one of the one or more vehicle applications may be executed within the runtime environment. For example, the runtime environment may be a virtual machine of a programming language, e.g., a Java virtual machine, or a runtime environment of a middleware, e.g. of an adaptive AUTomotive Open System ARchitecture (AUTOSAR). In embodiments, the vehicle computation unit may be a vehicular computer system being configured to execute one or more operating systems, e.g., via a hypervisor if more than one operating system is used. The one or more vehicle applications may be executed within the one or more applications system, e.g. within a runtime environment being executed within the system. The vehicle computation unit (e.g., the computation module) may be configured to execute the one or more vehicle applications within the operating system environment (e.g. within the runtime environment).

A communication of vehicle applications of the one or more vehicle applications is limited based on the one or more individual permission information manifests. For example, the method may include executing the one or more vehicle applications with limited communication permissions based on the one or more individual permission information manifests. The method may include providing a proxy and/or a serializer/de-serializer for the one or more vehicle applications, wherein the proxy and/or the serializer/de-serializer are configured to limit the communication based on the one or more individual permission information manifests and/or based on the one or more further individual permission information manifests. The method may include limiting the communication of the one or more vehicle applications based on the one or more individual permission information manifests. For example, the communication may be limited based on one or more filter rules and/or based on one or more firewall rules, wherein the one or more filter rules and/or based on one or more firewall rules are based on the one or more individual permission information manifests. For example, the method includes determining a communication permission data structure for the one or more vehicle applications based on the one or more individual permission information manifests. The communication of the one or more vehicle applications may be limited based on the one or more communication permission data structure. For example, the communication of a vehicle application of the one or more vehicle applications with further vehicle applications of the one or more vehicle applications may be limited based on the one or more individual permission information manifests. Additionally or alternatively, the communication of a vehicle application of the one or more vehicle applications with further vehicle applications of one or more further vehicle applications is limited based on the one or more individual permission information manifests and based on one or more further individual permission information manifests.

In some examples, as shown in FIG. 1 b, the method further includes receiving 140 one or more further individual permission information manifests from one or more further vehicle computation units of the vehicle. Here, the one or more further individual permission information manifests are received 140 in response to a request by the vehicle computation unit. The method may further include transmitting (e.g., periodically transmitting or as required) the request to the one or more further vehicle computation units. Alternatively (or additionally in some cases) the one or more further individual permission information manifests may be received 140 as a broadcast of the one or more further vehicle computation units. For example, the one or more further individual permission information manifests may be received individually or as a combined package including the individual permission information manifests, e.g., as a compressed folder of individual permission information manifests, in concatenated form, or within a marked-up document with binary components. In embodiments, the one or more further individual permission information manifests may be distinguishable and/or separable within the combined package. The one or more further individual permission information manifests may be implemented similar to the one or more individual permission information manifests, but may be associated with one or more further vehicle applications to be or being executed by the one or more further vehicle computation units. Each permission information manifest of the one or more further individual permission manifests may include information related to one or more permitted vehicle services of a further vehicle application to be executed by the one or more further computation units. The communication of vehicle applications of the one or more vehicle applications may be limited further based on the one or more further individual permission information manifests. For example, the method may include determining 150 the communication permission data structure for the one or more vehicle applications based on the one or more individual permission information manifests and based on the one or more further individual permission information manifests. The communication permission data structure may indicate or define, which of the one or more vehicle applications are permitted to communicate with which further vehicle computation unit of the one or more further vehicle computation units. Additionally or alternatively, the communication permission data structure may indicate or define which of the one or more further vehicle computation units are permitted to communicate with which vehicle application of the one or more vehicle applications.

In some examples, the one or more individual permission information manifests each include a cryptographic signature of the individual permission information manifest. The cryptographic signature of a permission information manifest of a vehicle application may be based on a cryptographic key (e.g., a private cryptographic key of a vehicle manufacturer), based on the programming instructions of the vehicle application (e.g., based on a hash value of the programming instructions) and based on the information related to the one or more permitted vehicle service. The method may further include, as further shown in FIG. 1 b, validating 160 the individual permission information manifests based on the cryptographic signature. For example, the validating 160 of the individual permission information manifests may include verifying, that the cryptographic signature is derived from the cryptographic key, e.g., based on a public key of the vehicle manufacturer. The validating 160 of the individual permission information manifests may further include verifying that the signature is based on the programming instructions of the vehicle application, e.g., based on the hash value of the programming instructions, to detect a manipulation of the hash values included within the individual permission information manifests after the creation of the cryptographic signatures. For example, the validating 160 of the individual permission information manifests may include verifying, that the cryptographic signature is based on the hash value of the programming instructions as included in the individual permission information manifests, by generating hash values of the obtained 110 programming instructions, and by comparing the generated hash values with the hash value of the programming instructions as included in the individual permission information manifests. Furthermore, the validating 160 of the individual permission information manifests may include verifying, the validating 160 of the individual permission information manifests may include verifying, that the cryptographic signature is based on the individual permission information manifests, to detect a manipulation of the individual permission information manifests after the creation of the cryptographic signatures. In at least some embodiments, also the one or more further individual permission information manifests each include a cryptographic signature of the further individual permission information manifest. The method may further include, validating 160 the further individual permission information manifests based on the cryptographic signature. The further individual permission information manifests may be validated based on the cryptographic signature similar to the individual permission information manifests.

In some examples, as further shown in FIG. 1 b, the method further includes providing 170 (e.g., transmitting via the vehicular network) the one or more individual permission information manifests to one or more further vehicle computation units of the vehicle. For example, the one or more individual permission information manifests may be provided individually or as a combined package including the individual permission information manifests, e.g., as a compressed folder of individual permission information manifests, in concatenated form, or within a marked-up document with binary components. In embodiments, the one or more individual permission information manifests may be distinguishable and/or separable within the combined package. For example, the one or more further individual permission information manifests may be provided 170 in response to a request by the one or more further vehicle computation units. The method may further include (periodically) receiving the request. Alternatively or additionally, the one or more further individual permission information manifests may be transmitted 170 (e.g., periodically transmitted or upon change) as a broadcast to the one or more further vehicle computation units.

In some examples, the method includes obtaining 180 an update of a vehicle application of the one or more vehicle applications. The update may include updated programming instructions of the vehicle application and an updated permission information manifest. The method may further include providing 190 (all of) the one or more individual permission information manifests to the one or more further vehicle computation units of the vehicle, including the updated permission information manifest of the updated vehicle application. For example, the one or more individual permission information manifests may be provided 170 to the one or more further vehicle computation units with a versioning information. The versioning information for all of the one or more individual permission information manifests may be changed if an updated version of a vehicle application is obtained. The method may include changing the versioning information for all of the one or more individual permission information manifests if an updated version of a vehicle application is obtained, and providing 190 (all of) the one or more individual permission information manifests to the one or more further vehicle computation units of the vehicle with changed versioning information.

The interface 12 may correspond to one or more inputs and/or outputs for receiving and/or transmitting information, which may be in digital (bit) values according to a specified code, within a module, between modules or between modules of different entities. In embodiments, the computation module 14 may be implemented using one or more computation units, one or more processing units, one or more computation devices, one or more processing devices, any means for processing or computing, such as a processor, a computer or a programmable hardware component being operable with accordingly adapted software. In other words, the described function of the computation module 14 may as well be implemented in software, which is then executed on one or more programmable hardware components. Such hardware components may include a general-purpose processor, a Digital Signal Processor (DSP), a micro-controller, etc. More details and aspects of the method and/or the vehicle computation unit are mentioned in connection with the proposed concept or one or more examples described above or below (e.g., FIGS. 2 to 5b). The method and/or the vehicle computation unit may include one or more additional optional features corresponding to one or more aspects of the proposed concept or one or more examples described above or below. FIG. 2 shows a flow chart of a method for providing a permission information manifest for a vehicle application for a vehicle. The method may be executed outside the vehicle, e.g., within a server or datacenter of a vehicle manufacturer. The method includes obtaining 210 programming instructions of the vehicle application. The method further includes determining 220 information related to one or more permitted vehicle services of the vehicle application. For example, the information related to the one or more permitted vehicle services may be obtained from a configuration information for the generation of the permission information manifest. The information related to the one or more permitted vehicle services may be predefined before the generation of the permission information manifest. The information related to the one or more permitted services indicates one or more vehicle services the vehicle application is permitted to offer to further vehicle applications of the vehicle and/or one or more vehicle service of the further vehicle applications the vehicle application is permitted to use. The method further includes generating 230 the permission information manifest based on the information related to one or more permitted vehicle services of the vehicle application and based on the programming instructions of the vehicle application. The permission information manifest includes a cryptographic signature and the information related to the one or more permitted vehicle services. The generating of the permission information manifest includes generating the cryptographic signature for the permission information manifest based on a cryptographic key (e.g., a private cryptographic key of the vehicle manufacturer), based on the programming instructions of the vehicle application (e.g., based on a hash value of the programming instructions) and based on the information related to the one or more permitted vehicle services (e.g., based on a hash value of the information related to the one or more permitted vehicle services). The permission information manifest may include the cryptographic signature. The method may include signing the permission information manifest may with the cryptographic signature. In at least some embodiments, the method may further include providing the permission information manifest with the cryptographic signature to a vehicle computation unit of the vehicle.

More details and aspects of the method and/or the permission information manifest are mentioned in connection with the proposed concept or one or more examples described above or below (e.g. FIGS. 1 a to 1c, 3a to 5b). The method and/or permission information manifest may include one or more additional optional features corresponding to one or more aspects of the proposed concept or one or more examples described above or below.

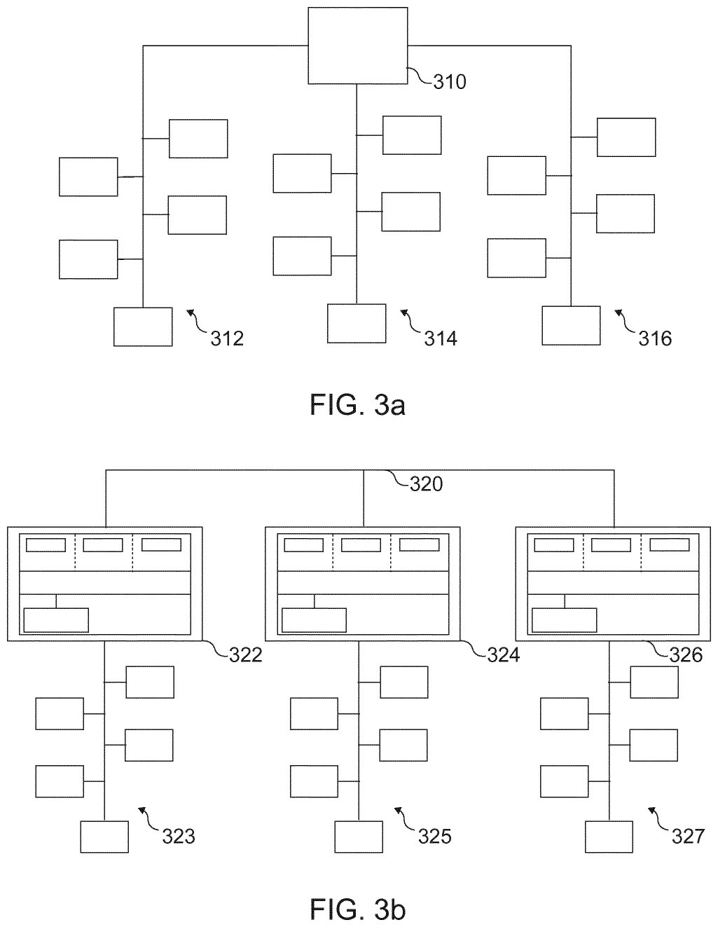

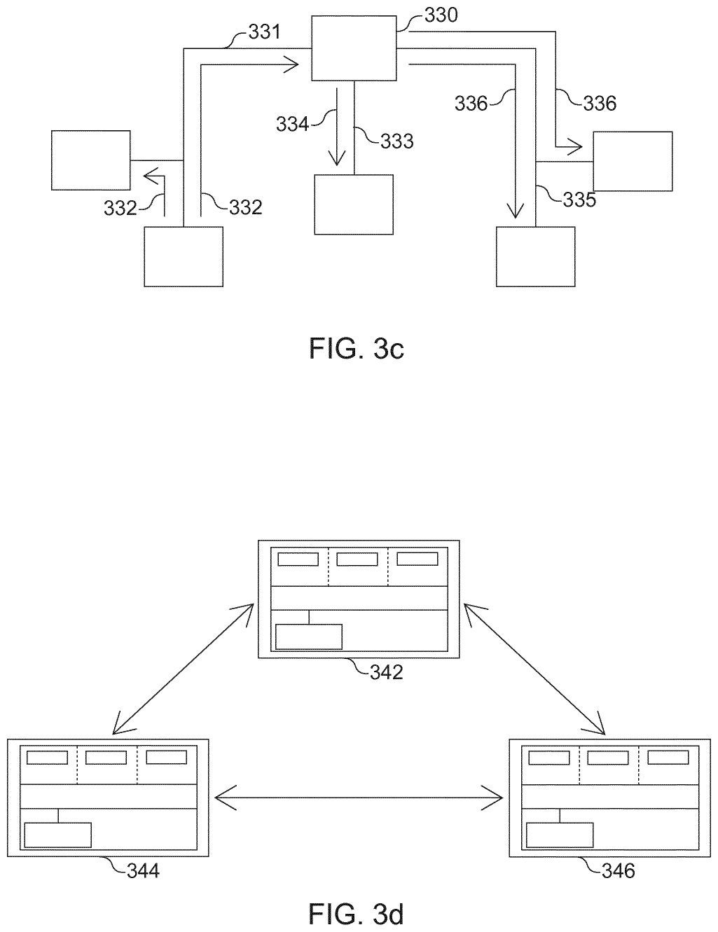

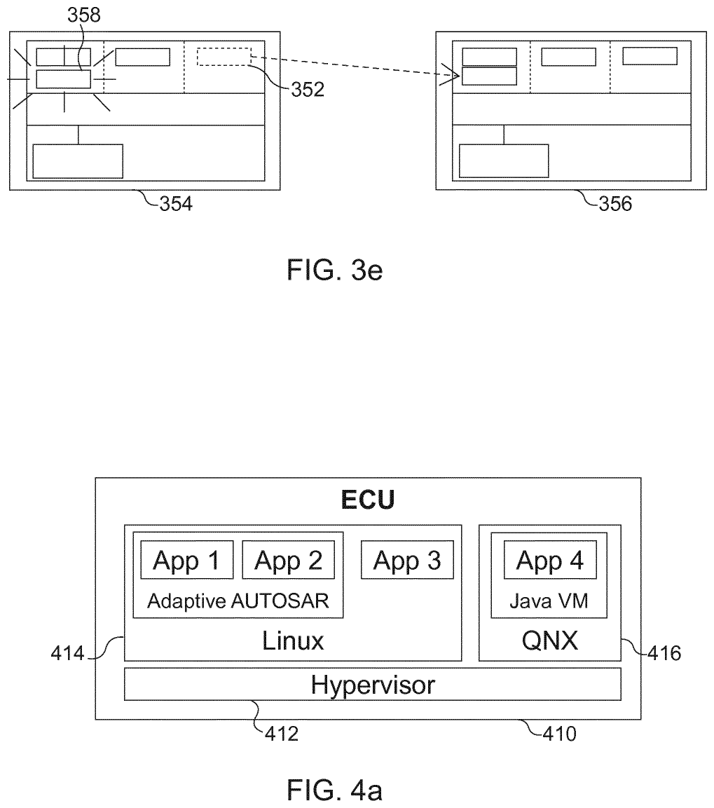

At least some examples disclosed herein may be based on service communication, a new communication paradigm that may create new security challenges. In the following, security implications of service communication may be detailed. Vehicle functions are increasing in complexity and resource requirements (e.g., Advanced Driver Assistance Systems/ADAS, online services) and may be required to be easily upgradable in the field. To address these increases in complexity and resource requirements, the vehicle network may be split into two layers. FIGS. 3a and 3b show architectural changes in the vehicle network. In FIG. 3a, a central gateway control unit 310 is used to connect branches 312; 314; 316 of control units of the vehicle. In FIG. 3b, the network is split into two layers, a high-performance compute layer of computation units 322; 324; 326 which hosts functions (e.g., the vehicle computation unit executing the one or more vehicle applications) and a low-performance sensor/actuator layer including units 323; 325; 327 which collects data and executes commands.

In the compute layer (e.g. among computation units), service communication may be used. An ECU (Electronic Control Unit, e.g. the vehicle computation unit) may host a service (e.g. “DoorStatus”) and announce it within the vehicle network. A client may locate a service during runtime:
Listening to service announcements
Broadcasting a FindService request for the requested service
Requesting the location from a central service registry which uses the above mechanisms
   After the service has been located the client may connect to the service and access its resources via a request/response mechanism (e.g. read the“DoorStatus/FrontLeft” resource to get information regarding the current status of the front left door) or via a publish/subscribe mechanism (e.g. subscribe to the“DoorStatus/FrontLeft” resource to be notified if the current status of the front left door changes).

FIGS. 3c and 3d show a comparison overview for service communication vs. signal communication. In signal communication, as shown in FIG. 3c, broadcast communication 332; 334; 336 is used on a single CAN (Controller Area Network) bus 331; 333; 335. Routing between different CAN busses is performed via a gateway 330. Very basic protocols are used (based on bitwise serialization), with a static configuration and low resource requirements. This architecture may be used in sensor / actuator layer communication, and may be translated to/from service communication inside the compute layer.

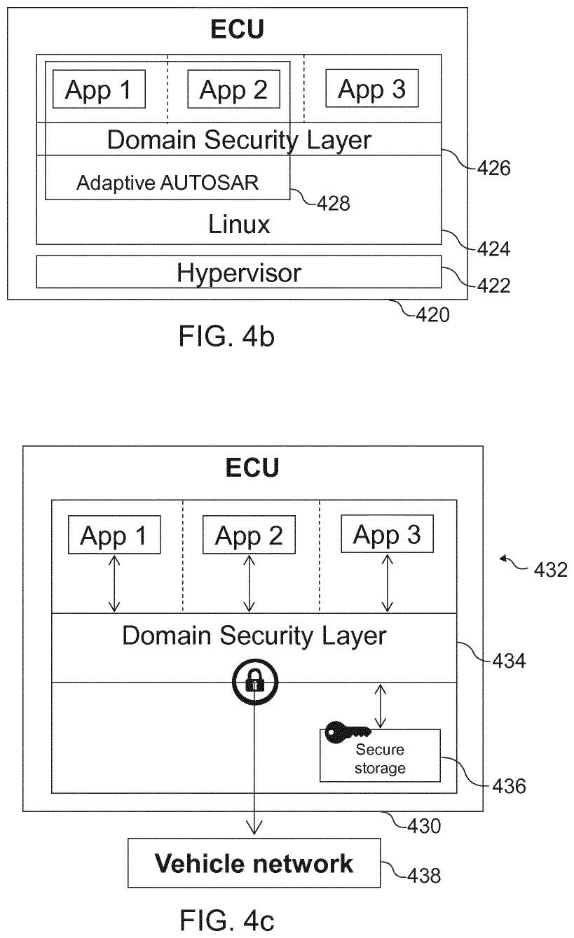

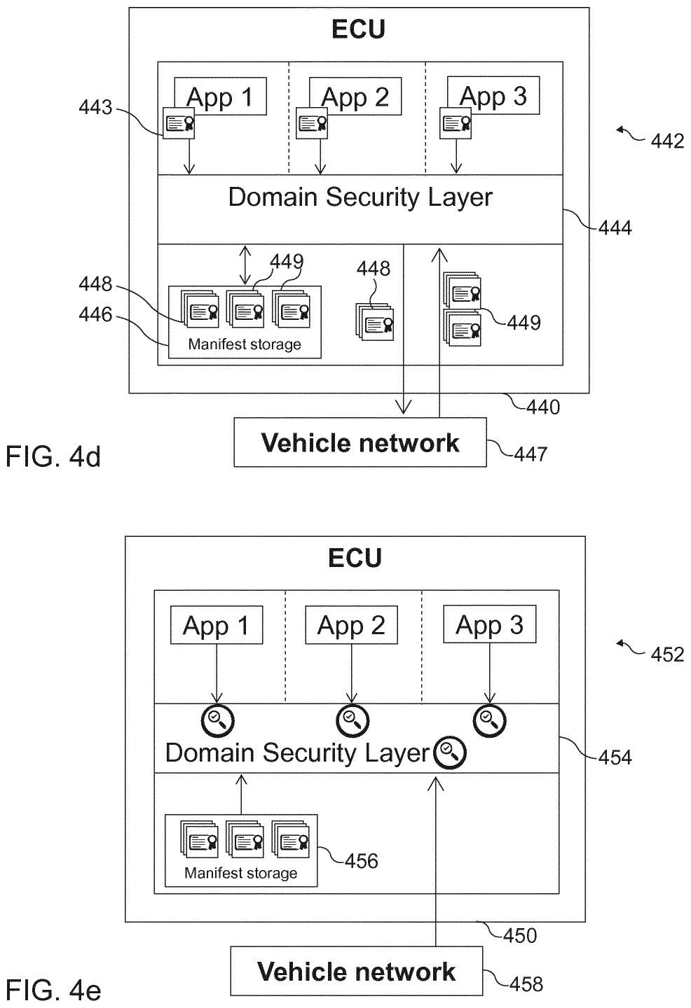

In service communication, as shown in FIG. 3d, IP-based communication over Ethernet may be used between nodes 342, 344 and 346. The nodes (e.g. computation units) may be introduced in more detail in connection with FIGS. 4a to 4e. Complex protocols, may be used, e.g. SOME/IP (Scalable service-Oriented MiddlewarE over IP, an automotive RPC (Remote Procedure Call) protocol via TCP (Transmission Control Protocol) and UDP (User Datagram Protocol)), Internet protocols (RESTful HTTP (Representational State Transfer-ful Hyper Text Transfer Protocol) web services, MQTT (Message Queuing Telemetry Transport), etc.), based on dynamic configuration, e.g., for vehicle applications/functions with high resource requirements. Service signaling may be used in compute layer communication.

Service communication may provide security challenges. In service communication, no central gateway might be used, so anyone can talk to anyone. Anyone might offer any service; anyone may consume any service. The service location might not be hardcoded, but determined during runtime. Impersonating a service provider or consumer may be easy.

As shown in FIG. 3e, service locations (e.g., of vehicle application 352, which may be transferred from ECU 354 to ECU 356) may change during a software update. Services and clients may be added (e.g., of vehicle application 358, which is added to ECU 354) during a software update. Furthermore, the communication architecture may change over the vehicle's lifetime.

Service communication may necessitate some service requirements, e.g., authentication and encryption communication and authorization communication. In authentication and encryption communication, service communication may be secured against local manipulation (e.g. odometer data). Certain service communication may require encryption (e.g., user login data). Not all service communication may need to be secured, so selective protection may be supported. Only one ECU of a type might be allowed in one car at a time (i.e., no clones). In authorized communication, a communicating entity (e.g., application) may be explicitly authorized to offer a service and/or a communicating entity may be explicitly authorized to consume a service and its resources (e.g., using permission information manifests). No single point of failure (both functionally and regarding security) may be present. Granting rights to a client might require a modification of at most one ECU (e.g., through the provision of the permission information manifests. Furthermore, the security concept may be independent of the communication protocol, and security mechanisms might not impair communication latency. Some approaches may be unsuitable for these requirements. For example, a central authorization ECU which holds and distributes access right lists to other ECUs may provide a Single point of failure, primary attack target. Furthermore, the central authorization ECU may be a communication bottleneck, doesn't scale, and may be susceptible to power management issues, as it must be online for others to communicate. In some cases, access right may be hardcoded. This would require a service ECU to be updated if rights need to be added for an updated client ECU. If a service were to be relocated, all clients might have to be changed. Furthermore, certificates for securing communication (e.g., via TLS (Transport Layer Security)) may be used. This may introduce latency because of slow handshake due to asymmetric cryptography. Furthermore, a revocation during ECU replacement may be complicated. Last, security on the application layer may be used. This may lead to a high effort for each application (access control checks, communication security, etc.), and applications may require access to keys.

Some examples may provide a security concept for service communication. FIG. 4a shows an exemplary software architect of a compute layer ECU (e.g., a vehicle computation unit as introduced in connection with FIGS. 1a to 1c). The ECU 410 may e.g., include a hypervisor 412, a Linux OS environment 414 with one vehicle application (App 3) being executed directly within the Linux OS, and two applications (App 1, App 2) being executed within an Adaptive AUTOSAR (AUTomotive Open System Architecture) runtime environment, and a QNX OS environment 416 with a Java Virtual Machine being used to execute a further vehicle application (App 4). The ECU may support“rich” operating systems and communication stacks. It may be POSIX (Portable Operating System lnterface)-based and Linux-based. It may support Adaptive AUTOSAR. One ECU (e.g., compute units) may host multiple virtualized environments. Nested container concepts may be used (Docker, Java VM etc.). Applications may perform service communication. It may be restricted regarding service consumption and provisioning.

FIG. 4b shows a block diagram of an exemplary security infrastructure inside an ECU 420. The ECU 420 includes a hypervisor 422 and a Linux OS environment 424, which is again used to execute an Adaptive AUTOSAR runtime environment 426 with vehicle applications 1 and 2, and to directly execute vehicle application 3. Additionally, a “Domain Security Layer” (DSL) 426 is used between the applications 1-3 and the Linux OS. The “Domain Security Layer” may be used to locally secure applications on sender and receiver side. It may provide separation of applications via sandboxing or containers. It may further provide reliable application identification. The DSL may enforce communication restrictions for each local application (e.g., limit the communication of a vehicle application) (e.g. by acting as a proxy). It may enforce communication restrictions for incoming communication from remote entities, and it may terminate secure communication, centralizes cryptographic key access. A DSL may consist of or include a set of complementing security mechanisms. Implementation of DSL may differ for each protocol, e.g., proxy for HTTP-based protocols or inside a data serializer/de-serializer for SOME/IP.

Furthermore, as shown in FIG. 4c, the DSL may be used to terminate authenticated communication. FIG. 4c shows an ECU 430, with applications 432 being executed on top of a DSL 434. The DSL is coupled to a secure storage 436. Applications 432 may use the DSL 434 to communicate via vehicle network 438. Thus, cryptographic keys might not be exposed to applications, lowering chance of compromise. TLS (TCP) and DTLS (Datagram Transport Layer Security, UDP) may be used for 1:1 communication. Custom mechanisms may be used for securing broadcast communication (e.g. SecOC, Secure Onboard Communication). Symmetric cryptography may be preferably used. Communication establishment is may be used. In at least some embodiments, no revocation issues may be present (if the key distribution mechanism is well-designed). The scaling may be solved by DSL acting as crypto proxy (avoiding per-app keys). In at least some cases, secure communication might (only) be used if necessary, hardware acceleration for encrypted communication may be used if possible.

Embodiments may provide authorized communication. FIG. 4d shows a schematic diagram of a permission distribution approach. FIG. 4d shows ECU 440 (e.g. the vehicle computation unit as introduced in connection with FIGS. la to lc) being used to execute applications 1 to 3 442. Each application may be associated with a security manifest 443 (e.g. a permission information manifest). These security manifest may be stored in a manifest storage 446 as group of manifests of the ECU 449 (e.g. the one or more individual permission information manifests). Furthermore, the manifest storage 446 may include further security manifests 448 of further ECUs (e.g. the one or more further individual permission information manifests). A DSL 444 has access to the security manifests. The group of manifests of the ECU 449 may be provided/transmitted by the DSL via the vehicle network 447, and the further security manifests 448 may be received by the DSL via the vehicle network 447. Each (vehicle) application may be provisioned with a signed security manifest containing the relevant information:
Application identity
Application's location (ECU, IP address etc.)
Communication whitelist (service provisioning and usage) Manifests may be generated offline and may be part of an application delivery. (All) ECU's security manifest collections may be synchronized (and cached) during runtime between all communication participants. (All) security manifests may be cryptographically verified by a DSL. The Signature verification key may be part of ECU software (e.g., in one-time programmable memory or a hardware security module).

Some examples may be based on authorized communication, with permission enforcement. FIG. 4e shows a schematic diagram of an ECU 450 executing applications 1 to 3 452. A DSL 454 with access to manifest storage 456 is used to check communication from apps and from the vehicle network 458 against an authentic database of permitted communication. The DSL may use the security manifests to build an authentic database of permitted communication. The database may be cached locally to avoid blocking communication during ECU start-up. The DSL may check all communication against the database. Local applications may be identified precisely and illegal communication may be blocked before they leave the ECU. Remote communication partners might (only) be reliably identified as the correct ECU.

In at least some examples, (all) ECUs may be configured as equal, concerning security and permission enforcement. Here, (all) ECUs may track (all) permissions inside the vehicle using the security manifests. Under such a configuration, permissions may be easily updated. New or modified applications may receive a new security manifest with the necessary changes. New or modified security manifests may be distributed during runtime, so no software modification might be necessary. A compromised ECU might not be able to elevate its communication permissions because other ECUs may restrict it based on its security manifests.

The examples laid out in the individual figures may be combined. For example, an ECU may combine at least some of the features of more than one figure. More details and aspects of the methods, the permission information fest and/or the vehicle computation unit are mentioned in connection with the proposed concept or one or more examples described above or below (e.g. FIGS. 1a to 2, 5a to 5b). The methods, the permission information fest and/or the vehicle computation unit may include one or more additional optional features corresponding to one or more aspects of the proposed concept or one or more examples described above or below.

In at least some embodiments, the permission information manifests may be based on capabilities. Each capability may designate a service and contain access permissions that control the operations (methods) of that service. Each capability may designate one service using a service name (service IDentifier) from a global service namespace. Each capability may contain one or more access permissions from the predefined set of access permissions for the designated service. Possession of a capability may grant an application the authority to register (offer) or invoke (use) the operations (methods) of the designated service for which the capability contains the corresponding access permission.

Each SOA (Service Oriented Architecture) application (e.g., an application of the one or more vehicle applications and/or of the one or more further vehicle applications) may be accompanied by one service-security manifest (e.g., one permission information manifest). The service-security manifest may be a separate metadata file that may be provided along with the SOA application. The service-security manifest may be named and stored such that there exists a one-to-one association between each SOA application and its service-security manifest. There might be no ambiguity which service-security manifest to use when loading a SOA application.

A possible implementation of the previous requirement may be to store the service-security manifest in the same persistent storage location (i.e., same partition, same directory) as the SOA application to which it belongs, using the same file name, but a different suffix. The service-security manifest may contain one domain name (domain ID) from the global domain namespace that designates the domain in which the SOA application may be authorized to run.

Service instances represented by different applications or service instances located in different SOA domains may have separate service-security manifests that designate in which SOA domain each service instance may be authorized to run.

The service-security manifest may contain one “server capabilities” section, which may contain only capabilities for those services that the application may be authorized (e.g., permitted) to register (offer). The section may be present and left empty if the application is not authorized to register (offer) any services.

The service-security manifest may contain one “client capabilities” section, which may contain only capabilities for those services that the application may be authorized to invoke (use). The section may be present and left empty if the application may be not authorized to invoke (use) any services. For each service that a SOA application may be authorized to register (offer), the “server capabilities” section of the service-security manifest (e.g., information related to the services the vehicle application is permitted to offer) may contain (exactly) one capability that designates (all of) the following:
a) the service—via the service name (service ID).
b) whether the service transmits confidential, authentic or untrustworthy data—via the security type.
c) the IP address and TCP/UDP port used by the service.

For each service that a SOA application may be authorized to invoke (use), the “client capabilities” section of the service-security manifest (e.g. information related to the services the vehicle application is permitted to use) may contain (exactly) one capability that designates (all of) the following:
a) the service—via the service name (service ID).
b) which operations (methods) of that service the application may be authorized to invoke (use)—via the access permissions.

The service-security manifest may contain one “integrity digest”, which facilitates the validation of the integrity of the application's image in normal memory. The integrity digest (e.g., the cryptographic signature) may be computed after the application binary (e.g., the application programming) has been built, i.e., when the service-security manifest for the application is being created.

The integrity digest may cover (all) code and read-only data pages of the application. The implementation may hash the content of those pages in ascending page order. The integrity digest may serve as a cryptographic binding between the application's in-memory image and the manifest that contains the capabilities for that application. The integrity digest may act as a unique fingerprint for validating both the identity and integrity of the application. If the integrity digest of the application's in-memory image is equal to the integrity digest from the manifest, then application and manifest belong to each other and the code of the application has not been tampered with. Other parts of the application may also be included in the integrity digest (e.g., shared libraries), but then the manifest would not only cover the application code itself, but the combination of application code and shared libraries. This may strengthen the integrity checks even more, but it may also require a manifest update whenever any of the application's shared libraries changes.

The service-security manifest may contain a cryptographic signature that facilitates the validation of the integrity and authenticity of the service-security manifest itself. The service-security manifest may be signed by the customer after reviewing and revising the manifest content. The signature may constitute customer approval of the manifest content.

The “manifest state” of a SOA domain may include the service-security manifests for all SOA applications that are in that domain. For example, if a domain contains X SOA applications, then the manifest state consists of the X service-security manifests for those SOA applications. The manifest state of each SOA domain may be associated with an integral “manifest state version number” larger than zero (e.g., the versioning information). Whenever a SOA application may be added, removed or updated in a SOA domain, the manifest state version number of that SOA domain may be incremented to deprecate all earlier (outdated) manifest states.

Each SOA domain may prevent a roll-back of the manifest state, i.e. it may only permit replacing an older manifest state (with a lower version number) with a newer manifest state (with a higher version number).

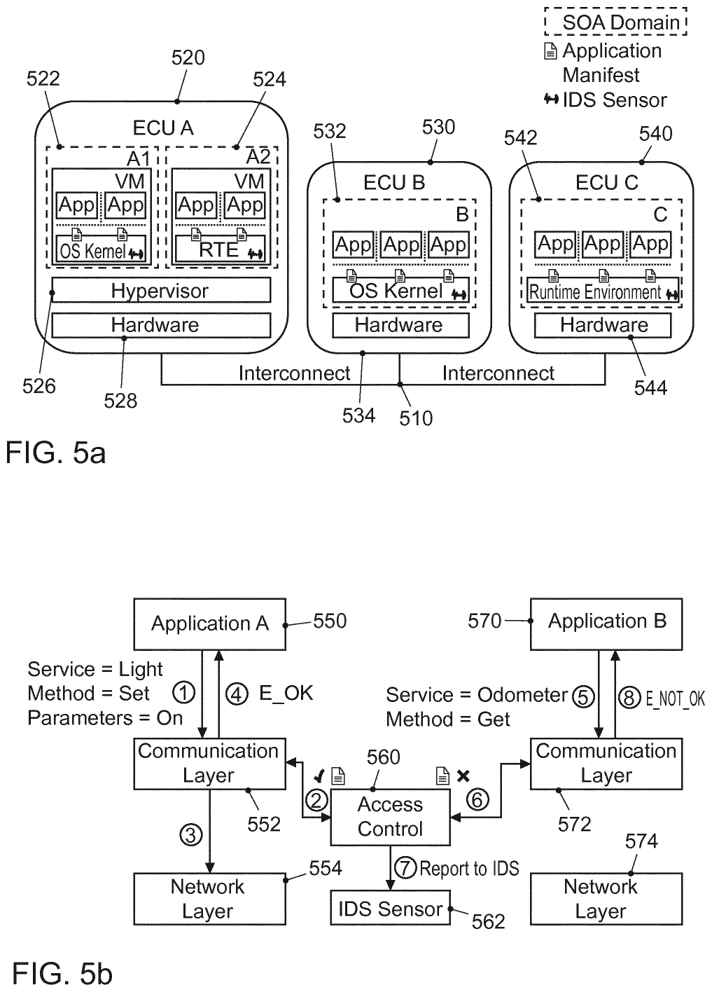

At least some embodiments may be based on executing the one or more vehicle applications using a domain security layer. The “domain security layer” may be a domain-specific software layer that can observe and control all service registrations and all service invocations of the SOA applications that are in that SOA domain. Possible domain security layers could be the operating system kernel, a runtime environment, a communication layer or a communication daemon through which all SOA operations are handled. In this configuration, software configured to act as the domain security layer may depend on the domain-internal software architecture and the communication protocol that may be used. A software component or communication layer that can interpose between SOA applications and the communication/network stack may be used as domain security layer. As an example, FIG. 5a illustrates a service-oriented architecture with four SOA domains. Each SOA domain is shown with dashed lines, and the software layer that acts as domain security layer is denoted below.

FIG. 5a shows three computation units/control units ECU (Electronic Control Unit) 520; 530; 540 that are connected via an interconnect 510. ECU A 520 includes two SOA domains Al 522 and A2 524, which are executed on hardware 528 via a hypervisor 526. SOA domain Al 522 includes two vehicle applications, which are mutually separated, and an Operating System (OS) Kernel, which is separated from the vehicle applications, and which serves as domain security layer. The OS Kernel obtains the application manifests (e.g., the permission information manifests), and includes an Intrusion Detection System (IDS) sensor. SOA domain A2 524 also includes two vehicle applications, which are mutually separated, and a RunTime Environment (RTE), which is separated from the vehicle applications. In this case, the RTE serves as domain security layer, obtains the application manifests (e.g., the permission information manifests), and includes an Intrusion Detection System (IDS) sensor. ECU B 530 includes three vehicle applications in a SOA domain 532 that are mutually separated, and an OS kernel that is separated from the three vehicle applications, and which is executed on hardware 534. In this case, the OS kernel serves as domain security layer, obtains the application manifests (e.g., the permission information manifests), and includes an Intrusion Detection System (IDS) sensor. ECU C 540 includes three vehicle applications in an SOA domain 542 that are mutually separated, and a RTE that is separated from the three vehicle applications, and which is executed on hardware 544. In this case, the RTE serves as domain security layer, obtains the application manifests (e.g., the permission information manifests), and includes an Intrusion Detection System (IDS) sensor.

In each SOA domain, the domain security layer may be implemented outside the SOA applications, in a separate, protected execution environment, where none of the SOA applications can interfere with it. As an example, the domain security layer may be implemented in a more privileged processor mode (e.g., an OS kernel running in supervisor mode), in a controlling runtime environment (RTE), or in a separate process.

The domain security layer may execute each SOA application in a separate, protected execution environment (e.g., dedicated process), where none of the other SOA applications can interfere with it.

The domain security layer may establish a fixed association between the protected execution environment (e.g., process) that executes a SOA application and the SOA application's service- security manifest at application launch time. The association may be such that the domain security layer can subsequently attribute each service registration and each service invocation that originates from that protected execution environment to the invoking SOA application and perform a primary access-control check against the service-security manifest of that application.

The domain security layer may intercept (all) service registrations and all service invocations of the SOA applications that are in its domain and perform a primary access-control check on each such operation. The primary access-control check may determine if the service-security manifest of the application contains a capability that authorizes the operation.

As an example, FIG. 5b illustrates the primary access-control check for two applications. Application A 550 invokes the “Light” service with the method “Set” (1). The domain security layer 552, 560 (communication layer) performs an access-control check against the service- security manifest of A and determines that the operation may be authorized (2). Therefore, the domain security layer 552 transforms the function call into a request for the network (3) 554 and returns no error for the operation (4). Application B 570 invokes the “Odometer” service with the method “Get” (5). The domain security layer 572, 560 (communication layer) performs an access control-check against the service-security manifest of B and determines that the operation may be denied (6). Therefore, the domain security layer 572, 570, 560, 562 generates an IDS event (7) and returns an error for the operation (8). Network layer 564 is not invoked.

The implementation of the domain security layer may ensure that no service registration and no service invocation operations can bypass the access-control checking in the domain security layer. The domain security layer may maintain strict isolation between the different execution environments (e.g., processes), such that no SOA application can impersonate any other SOA application or use the capabilities from another application's service-security manifest to register (offer) or invoke (use) services that are not authorized by its own capabilities.

The domain security layer may implement the entire access-control checking in such a way that it may be completely transparent to SOA applications. Whenever an operation is denied by access control, the domain security layer may indicate the failure using a suitable protocol- specific error code. SOA applications neither need to know that they have a service-security manifest, nor what may be contained in that manifest.

More details and aspects of the methods, the permission information fest and/or the vehicle computation unit are mentioned in connection with the proposed concept or one or more examples described above or below (e.g., FIGS. 1a to 4e). The methods, the permission information fest and/or the vehicle computation unit may include one or more additional optional features corresponding to one or more aspects of the proposed concept or one or more examples described above or below.

As already mentioned, in embodiments the respective methods may be implemented as computer programs or codes, which can be executed on a respective hardware. Hence, another embodiment is a computer program having a program code for performing at least one of the above methods, when the computer program is executed on a computer, a processor, or a programmable hardware component. A further embodiment includes a computer-readable storage medium storing instructions which, when executed by a computer, processor, or programmable hardware component, cause the computer to implement one of the methods described herein.

A person of skill in the art would readily recognize that steps of various above-described methods can be performed by programmed computers, for example, positions of slots may be determined or calculated. Herein, some embodiments are also intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as magnetic disks and magnetic tapes, hard drives, or optically readable digital data storage media. The embodiments are also intended to cover computers programmed to perform said steps of methods described herein or (field) programmable logic arrays ((F)PLAs) or (field) programmable gate arrays ((F)PGAs), programmed to perform said steps of the above-described methods.

The description and drawings merely illustrate the principles of the disclosure. It will thus be appreciated that those skilled in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, Digital Signal Processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the detailed description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective steps of these methods.

### LIST OF REFERENCE SIGNS

10 Vehicle computation unit

12 Interface

14 Computation module

20 One or more further computation modules

100 Vehicle

100a Vehicle

100b One or more other vehicle computation units

110 Obtaining programming instructions

120 Obtaining one or more individual permission information manifests

130 Executing one or more vehicle applications

140 Receiving one or more further individual permission information manifests

150 Determining a communication permission data structure

160 Validating the individual permission information manifests

170 Providing the one or more individual permission information manifests

180 Obtaining an updated of a vehicle application

190 Providing all of the one or more individual permission information manifests

210 Obtaining programming instructions

220 Determining information related to one or more permitted vehicle services

230 Generating a permission information manifest

310 Gateway control unit

312, 314, 316 Branches of control units

322, 324, 326 Computation units

323, 325, 327 Units of the sensor/actuator layer

330 Gateway

331, 333, 335 CAN bus

332, 334, 336 Broadcast communication

342, 344, 346 Ethernet nodes

352 Vehicle application

354, 356 ECU

358 Vehicle application

410 ECU

412 Hypervisor

414 Linux OS environment

416 QNX OS environment

420 ECU

422 Hypervisor

424 Linux OS environment

426 Adaptive AUTOSAR runtime environment

430 ECU

432 Applications

434 Domain security layer

436 Secure storage

438 Vehicle network

440 ECU

442 Applications

443 Security manifest

444 Domain security layer

446 Manifest storage

447 Vehicle network

448 Further security manifests

449 Manifests of the ECU

450 ECU

1. A method for executing one or more vehicle applications using a vehicle computation unit of a vehicle, the method comprising:
obtaining programming instructions of the one or more vehicle applications;
obtaining one or more individual permission information manifests of the one or more vehicle applications, wherein each permission information manifest of the one or more individual permission manifests comprises information related to one or more permitted vehicle services of a vehicle application of the one or more vehicle applications, wherein the information related to the one or more permitted services indicates
one or more vehicle services the vehicle application is permitted to offer to further vehicle applications of the vehicle, and/or
one or more vehicle services of the further vehicle applications the vehicle application is permitted to use; and
executing the one or more vehicle applications based on the programming instructions and based on the one or more individual permission information manifests using the vehicle computation unit, wherein a communication of vehicle applications of the one or more vehicle applications is limited based on the one or more individual permission information manifests.

2. The method according to claim 1, further comprising receiving one or more further individual permission information manifests from one or more further vehicle
computation units of the vehicle, wherein each permission information manifest of the one or more further individual permission manifests comprises information related to one or more permitted vehicle services of a further vehicle application to be executed by the one or more further computation units, wherein the communication of vehicle applications of the one or more vehicle applications is limited based on the one or more further individual permission information manifests.

3. The method according to claim 2, further comprising determining a communication permission data structure for the one or more vehicle applications based on the one or more individual permission information manifests and based on the one or more further individual permission information manifests, wherein the communication of the one or more vehicle applications are limited based on the communication permission data structure.

4. The method according to claim 3,
wherein the communication permission data structure indicates which of the one or more vehicle applications are permitted to communicate with which further vehicle computation unit of the one or more further vehicle computation units, and/or
wherein the communication permission data structure indicates which of the one or more further vehicle computation units are permitted to communicate with which vehicle application of the one or more vehicle applications.

5. The method according to claim 2, wherein the one or more further
individual permission information manifests are received in response to a request by the vehicle computation unit, or wherein the one or more further individual permission information manifests are received as a broadcast of the one or more further vehicle computation units.

6. The method according to claim 1, wherein the one or more individual permission information manifests each comprise a cryptographic signature of the individual permission information manifest, wherein the cryptographic signature comprises a cryptographic key, based on the programming instructions of the vehicle application, and based on the information related to the one or more permitted vehicle services, and further comprising validating the individual permission information manifests based on the cryptographic signature.

7. The method according to claim 1, further comprising providing the one or more individual permission information manifests to one or more further vehicle computation units of the vehicle.

8. The method according to claim 7, wherein the one or more further individual permission information manifests are provided in response to a request by the one or more further vehicle computation units, or wherein the one or more further individual permission information manifests are transmitted as a broadcast to the one or more further vehicle computation units.

9. The method according to one of the claim 7, further comprising:
obtaining an update of a vehicle application of the one or more vehicle applications, wherein the update comprises updated programming instructions of the vehicle application and an updated permission information manifest; and
providing all of the one or more individual permission information manifests to the one or more further vehicle computation units of the vehicle, including the updated permission information manifest of the updated vehicle application.

10. The method according to one of the claim 7, wherein the one or more individual permission information manifests are provided to the one or more further vehicle computation units with a versioning information, wherein the versioning information for all of the one or more individual permission information manifests is changed if an updated version of a vehicle application is obtained.

11. The method according to claim 2,
wherein the communication of the vehicle application of the one or more vehicle applications with further vehicle applications of the one or more vehicle applications is limited, based on the one or more individual permission information manifests, and/or
wherein the communication of the vehicle application of the one or more vehicle applications with further vehicle applications of one or more further vehicle applications is limited based on the one or more individual permission information manifests and based on one or more further individual permission information manifests.

12. A method for providing a permission information manifest for a vehicle application for a vehicle, the method comprising:
obtaining programming instructions of the vehicle application;
determining information related to one or more permitted vehicle services of the vehicle application, wherein the information related to the one or more permitted services indicates one or more vehicle services the vehicle application is permitted to offer to further vehicle applications of the vehicle and/or one or more vehicle service of the further vehicle applications the vehicle application is permitted to use; and
generating a permission information manifest based on the information related to one or more permitted vehicle services of the vehicle application and based on the programming instructions of the vehicle application, wherein the permission information manifest comprises a cryptographic signature and the information related to the one or more permitted vehicle services, wherein the generating of the permission information manifest comprises generating the cryptographic signature for the permission information manifest based on a cryptographic key, based on the programming instructions of the vehicle application and based on the information related to the one or more permitted vehicle services.

13. The method of claim 12, further comprising validating the individual permission information manifests based on the cryptographic signature.

14. A vehicle computation unit for a vehicle, wherein the vehicle computation unit is configured to execute one or more vehicle applications, the vehicle computation unit comprising: an interface for communicating with one or more further vehicle computation units of the vehicle; and a computation module (14) configured to:
obtain programming instructions of the one or more vehicle applications,
obtain one or more individual permission information manifests of the one or more vehicle applications, wherein each permission information manifest of the one or more individual permission manifests comprises information related to one or more permitted vehicle services of a vehicle application of the one or more vehicle applications, wherein the information related to the one or more permitted services indicates one or more vehicle services the vehicle application is permitted to offer to further vehicle applications of the vehicle and/or one or more vehicle services of the further vehicle applications the vehicle application is permitted to use, and
execute the one or more vehicle applications based on the programming instructions and based on the one or more individual permission information manifests, wherein a communication of vehicle applications of the one or more vehicle applications is limited based on the one or more individual permission information manifests.

15. A permission information manifest for a vehicle application,
wherein the permission information manifest is based on information related to one or more permitted vehicle services of the vehicle application and based on programming instructions of the vehicle application,
wherein the information related to the one or more permitted services indicates one or more vehicle services the vehicle application is permitted to offer to further vehicle applications of the vehicle and/or one or more vehicle service of the further vehicle applications the vehicle application is permitted to use,
wherein the permission information manifest comprises a cryptographic signature and the information related to the one or more permitted vehicle services,
wherein the cryptographic signature of the permission information manifest is based on a cryptographic key, based on the programming instructions of the vehicle application and based on the information related to the one or more permitted vehicle services,
wherein the vehicle application is executed based on validating the permission information manifest based on the cryptographic signature.
